(19) United States
(12) Patent Application Publication
(10) Pub. No.: US 2025/0043900 A1
(43) Pub. Date: Feb. 6, 2025

(54) PIPE ATTACHMENT STRUCTURE AND BRACKET

(71) Applicant: Isuzu Motors Limited, Kanagawa (JP)

(72) Inventors: Daijiro TANAKA, Fujisawa-shi, Kanagawa (JP); Tatsuya TSUZUKI, Fujisawa-shi, Kanagawa (JP)

(73) Assignee: Isuzu Motors Limited, Kanagawa (JP)

(21) Appl. No.: 18/715,760

(22) PCT Filed: Sep. 15, 2022
(86) PCT No.: PCT/JP2022/034544

§ 371 Date: Jun. 3, 2024

(30) Foreign Application Priority Data
Dec. 8, 2021 (JP) 2021-199216

(51) Int. Cl. F16L 57/02; F16L 3/02

(52) U.S. Cl. CPC F16L 57/02; F16L 3/02

(57) ABSTRACT

Provided are a pipe attachment structure (1) and a bracket (20) that minimize breakage of a pipe (10). This pipe attachment structure is mounted on a moving body and a pipe through which a fluid flows is attached to a predetermined component via a bracket, wherein the bracket has a flange part (23) formed into a flange by bending the bracket such that of the portion that attaches to the outer peripheral surface of the pipe, the end part in the flowing direction of the fluid separates from the outer peripheral surface of the pipe.

### TECHNICAL FIELD

The present disclosure relates to a pipe attachment structure and a bracket.

### BACKGROUND ART

It has been known (refer to, for example, PTL 1) to use in a moving object (for example, a vehicle or the like) a bracket as a section that attaches a pipe, through which a fluid (for example, engine cooling water or the like) flows, to a predetermined component (for example, an intake manifold or the like).

### CITATION LIST

### Patent Literature

### PTL 1

Japanese Patent Application Laid-Open No. 2011-106752

### SUMMARY OF INVENTION

### Technical Problem

There is, however, a likelihood of vibration or the like of the moving object causing concentration of stress at the bracket and causing breakage of the pipe.

An object of one aspect of the present disclosure is to provide a pipe attachment structure and a bracket that are capable of suppressing breakage of a pipe.

### Solution to Problem

A pipe attachment structure according to one aspect of the present disclosure is a structure mounted on a moving object and including a pipe through which a fluid flows is attached via a bracket to a predetermined component, in which the bracket includes a flange portion that is formed into a flange shape by bending an end portion of a part of the bracket such that the end portion is separated from an outer peripheral surface of the pipe, the part of the bracket being attached to the outer peripheral surface of the pipe, the end portion being an end portion in a flow direction of the fluid.

A bracket according to one aspect of the present disclosure is mounted on a moving object and used for attaching a pipe through which a fluid flows to a predetermined component, the bracket including: a flange portion that is formed into a flange shape by bending an end portion of a part of the bracket such that the end portion is separated from an outer peripheral surface of the pipe, the part of the bracket being attached to the outer peripheral surface of the pipe, the end portion being an end portion in a flow direction of the fluid.

### Advantageous Effects of Invention

According to the present disclosure, it is possible to suppress breakage of a pipe.

### BRIEF DESCRIPTION OF DRAWINGS

FIG. 1 illustrates an appearance of the surface side of a pipe attachment structure and a bracket according to an embodiment of the present disclosure;

FIG. 2 illustrates an appearance of the back side of the pipe attachment structure and the bracket according to an embodiment of the present disclosure;

FIG. 3 illustrates an appearance of the surface side of the pipe attachment structure and the bracket according to an embodiment of the present disclosure as viewed from obliquely below; and

FIG. 4 illustrates an appearance of the surface side of the pipe attachment structure and the bracket according to an embodiment of the present disclosure as viewed from obliquely above.

### DESCRIPTION OF EMBODIMENTS

Hereinafter, an embodiment of the present disclosure will be described with reference to the drawings. Note that components common among the drawings are given identical signs, and description of these components are omitted, as appropriate.

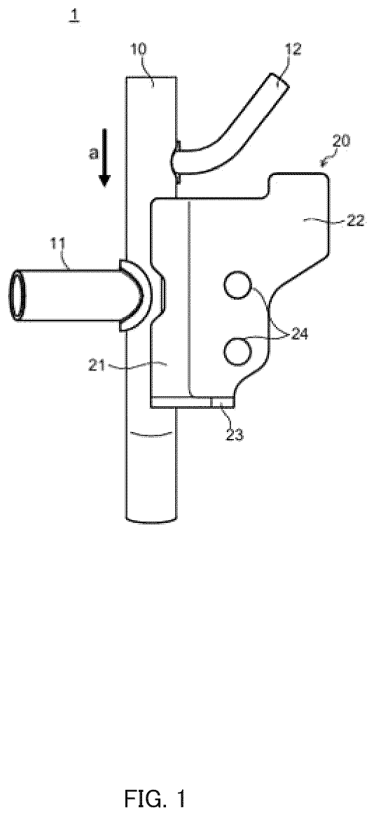

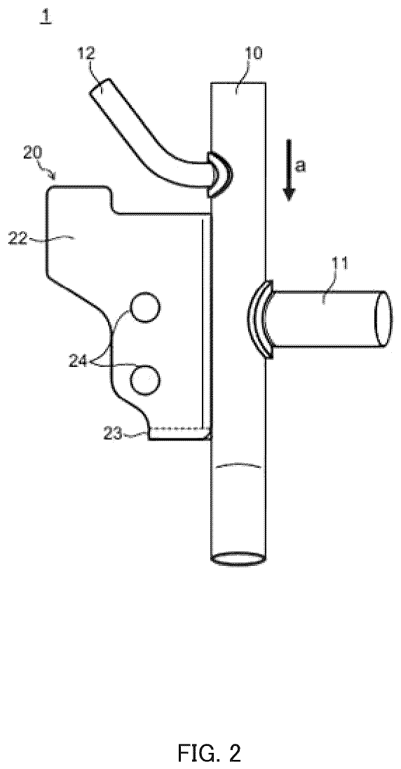

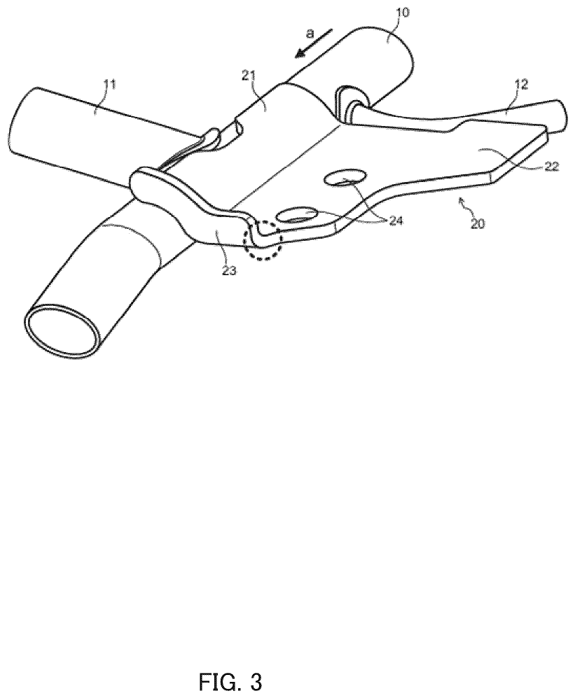

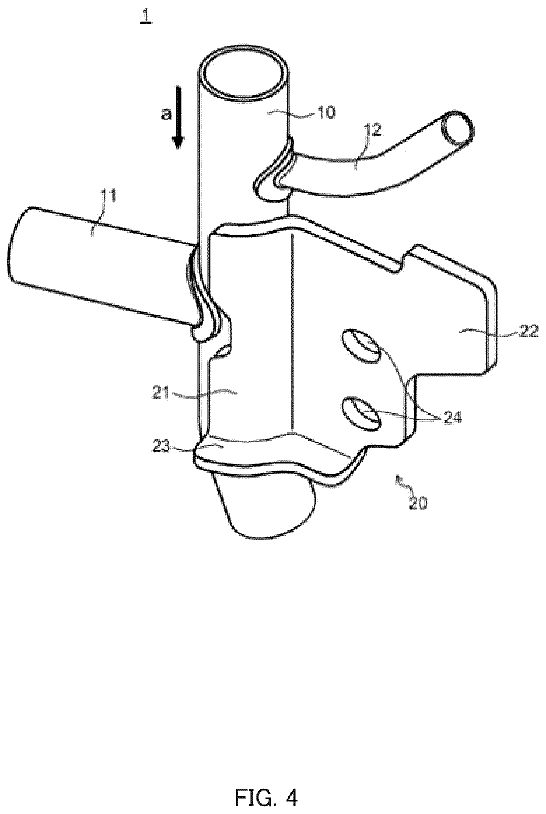

FIG. 1 illustrates an appearance of the surface side of pipe attachment structure 1 and bracket 20 in the present embodiment. FIG. 2 illustrates an appearance of the back side of pipe attachment structure 1 and bracket 20 in the present embodiment. FIG. 3 illustrates an appearance of the surface side of pipe attachment structure 1 and bracket 20 in the present embodiment as viewed from obliquely below. FIG. 4 illustrates an appearance of the surface side of pipe attachment structure 1 and bracket 20 in the present embodiment as viewed from obliquely above.

Pipe attachment structure 1 illustrated in FIG. 1 to FIG. 4 is, for example, mounted on an automobile (one example of a moving object) on which an internal combustion engine is mounted.

As illustrated in FIG. 1 to FIG. 4, pipe attachment structure 1 includes main pipe 10, first branch pipe 11, second branch pipe 12, and bracket 20.

First branch pipe 11 and second branch pipe 12 are connected to main pipe 10.

For example, cooling water (one example of a fluid) for cooling an internal combustion engine of an automobile flows through main pipe 10, first branch pipe 11, and second branch pipe 12. Arrow a illustrated in each of FIG. 1 to FIG. 4 indicates a flow direction of the cooling water in main pipe 10. Thus, for example, the cooling water flows from an upper location toward a lower location in FIG. 1 and FIG. 2.

The cooling water that flows through second branch pipe 12 flows into main pipe 10. The cooling water that flows through main pipe 10 diverges from main pipe 10 and flows into first branch pipe 11.

Bracket 20 is a member for attaching main pipe 10 to a predetermined component.

As illustrated in FIG. 1 to FIG. 4, bracket 20 includes curved portion 21, flat portion 22, and flange portion 23.

Curved portion 21 has a curved shape based on the curvature of the outer peripheral surface of main pipe 10 and serves as a part that is attached to the outer peripheral surface of main pipe 10.

Specifically, the entirety of curved portion 21 is attached by brazing to the outer peripheral surface of main pipe 10. Consequently, curved portion 21 is fixed to main pipe 10.

Flat portion 22 has a flat shape and serves as a part that is attached to a predetermined component mounted on an automobile.

Flat portion 22 has two bolt holes 24. Bolts, which are not illustrated, are each inserted into a corresponding one of bolt holes 24, and the bolts are each inserted into a corresponding one of bolt holes provided in the predetermined component (for example, an intake manifold or the like), which is not illustrated. In other words, flat portion 22 is fastened (fixed) to the predetermined component by bolt-tightening. The predetermined component described here is preferably, for suppression of breakage thereof, a component that is not largely vibrated.

Flange portion 23 is a portion that is formed into a flange shape by bending a lower end portion (an end portion of bracket 20, the end portion being an end portion on the downstream side in the flow direction of the cooling water) of bracket 20 such that the lower end portion is separated from the outer peripheral surface of main pipe 10.

Specifically, the lower end portion (the lower end portion of curved portion 21 and the lower end portion of flat portion 22) of bracket 20 is bent at the right angle (90 degrees) with respect to the outer peripheral surface of main pipe 10. Consequently, the lower end portion of bracket 20 projects (protrudes) in a direction perpendicular to the flow direction (see arrow a) of the cooling water and serves as flange portion 23 that has a certain height from the outer peripheral surface of main pipe 10.

A portion (a corner portion at the base of flange portion 23; see the circle of the dotted line in FIG. 3) at which the lower end portion of bracket 20 is bent is curved.

According to the configurations described above, the following effects can be obtained in the present embodiment.

Generally, in a part of a bracket attached to a pipe, a lower end portion of the bracket has an edge shape, and thus, a stress generated by vibration (for example, vibration in the direction indicated by arrow a and a direction opposite thereto) of an automobile easily concentrates at the lower end portion of the bracket. Therefore, the outer peripheral surface of the pipe in contact with the lower end portion of bracket 20 is likely to be broken.

Thus, in the present embodiment, the lower end portion of bracket 20 is bent to be separated from the outer peripheral surface of main pipe 10 and thereby formed into a flange shape, as illustrated in FIG. 1 to FIG. 4. Consequently, concentration of stress can be avoided, and breakage of main pipe 10 can be suppressed.

In addition, since flange portion 23 projects from the outer peripheral surface of main pipe 10 to have a certain height, flange portion 23 acts as a reinforcement rib and can exert high strength in the direction of vibration.

Meanwhile, as measures to avoid concentration of stress, for example, an increase in a plate thickness, an addition of a reinforcement material, a change of a material, and the like are generally performed. Compared with those measures, bracket 20 can avoid concentration of stress at low costs with a small space.

In addition, the bent portion of the lower end portion of bracket 20 is curved and thus has no edge. Consequently, concentration of stress can be further suppressed.

Note that the present disclosure is not limited by the description of the aforementioned embodiment and can be variously modified within the scope not deviating from the gist of the present disclosure. Hereinafter, modifications will be described.

### [Modification 1]

In the embodiment, a case in which first branch pipe 11 and second branch pipe 12 are connected to main pipe 10 has been described as an example. However, these branch pipes may be not provided.

### [Modification 2]

In the embodiment, a case in which the bent angle of the lower end portion of bracket 20 is 90 degrees (right angle) has been described as an example. The bent angle is, however, not limited thereto. For example, the bent angle may be 90 degrees or smaller. Meanwhile, employing the bent angle of 90 degrees has an advantage that bending is easily and an effect of the reinforcement rib is improved.

### [Modification 3]

In the embodiment, a case in which the lower end portion of bracket 20 is bent to be served as flange portion 23 has been described as an example. The flange portion 23 is, however, not limited thereto. For example, an upper end portion of bracket 20 may be bent (for example, at the right angle) to be separated from the outer peripheral surface of main pipe 10 into a flange shape.

### [Modification 4]

In the embodiment, a case in which the fluid that flows through main pipe 10 is the cooling water of the internal combustion engine has been described as an example. Main pipe 10 is, however, not limited thereto. For example, main pipe 10 may be a pipe through which an oil for use in an internal combustion engine flows or a pipe through which an automatic transmission fluid (ATF) for use in an automatic speed changer or an automatic transmission flows.

### [Modification 5]

In the embodiment, a case in which pipe attachment structure 1 and bracket 20 are mounted on an automobile has been described as an example. Pipe attachment structure 1 and bracket 20 are, however, not limited thereto and may be mounted on a moving object (for example, a two-wheeled vehicle, a ship, or the like) other than automobiles.

The present application is based on Japanese Patent Application (Japanese Patent Application No. 2021-199216), filed on Dec. 8, 2021, the contents of which are incorporated herein by reference.

### INDUSTRIAL APPLICABILITY

The pipe attachment structure and the bracket according to the present disclosure are useful as a technology that attaches a pipe, through which a fluid flows, to a predetermined component via a bracket.

### REFERENCE SIGNS LIST

1 pipe attachment structure
10 main pipe
11 first branch pipe
12 second branch pipe
20 bracket
21 curved portion
22 flat portion
23 flange portion
24 bolt hole

1. A pipe attachment structure mounted on a moving object and including a pipe through which a fluid flows is attached via a bracket to a predetermined component,
wherein the bracket includes a flange portion that is formed into a flange shape by bending an end portion of a part of the bracket such that the end portion is separated from an outer peripheral surface of the pipe, the part of the bracket being attached to the outer peripheral surface of the pipe, the end portion being an end portion in a flow direction of the fluid.

2. The pipe attachment structure according to claim 1,
wherein the end portion is an end portion on a downstream side in the flow direction of the fluid.

3. The pipe attachment structure according to claim 1,
wherein the end portion is bent at a right angle with respect to the outer peripheral surface of the pipe.

4. The pipe attachment structure according to claim 1,
wherein a portion at which the end portion is bent is curved.

5. The pipe attachment structure according to claim 1,
wherein the bracket is attached to the outer peripheral surface of the pipe by brazing.

6. The pipe attachment structure according to claim 1,
wherein the fluid is cooling water for cooling an internal combustion engine of the moving object.

7. A bracket mounted on a moving object and used for attaching a pipe through which a fluid flows to a predetermined component, the bracket comprising:
a flange portion that is formed into a flange shape by bending an end portion of a part of the bracket such that the end portion is separated from an outer peripheral surface of the pipe, the part of the bracket being attached to the outer peripheral surface of the pipe, the end portion being an end portion in a flow direction of the fluid.
